(19) United States
(12) Patent Application Publication
(10) Pub. No.: US 2024/0051792 A1
(43) Pub. Date: Feb. 15, 2024

(54) ELEVATOR MONITORING SYSTEM

(71) Applicant: Inventio AG, Hergiswil (CH)

(72) Inventor: Christopher Mason, Ledgewood, NJ (US)

(21) Appl. No.: 18/257,885

(22) PCT Filed: Dec. 17, 2021
(86) PCT No.: PCT/EP2021/086358

§ 371 Date: Jun. 16, 2023

Related U.S. Application Data
(60) Provisional application No. 63/199,415, filed on Dec. 24, 2020.

(30) Foreign Application Priority Data
Jan. 29, 2021 (EP) 21154422.6

(51) Int. Cl. B66B 5/00

(52) U.S. Cl. CPC B66B 5/0018

(57) ABSTRACT

An elevator monitoring system includes a monitoring controller for communicating with a remote monitoring installation. The monitoring controller has a signal input for connecting the monitoring controller to a sensor system of the elevator monitoring system. The sensor system includes a first sensor module for determining a state of an elevator controller of an elevator system monitored by the elevator monitoring system, and a second sensor module for determining movement information of the monitored elevator system. The sensor system combines an output state of the first sensor module and an output state of the second sensor module into a single output state by a logical AND operation and provides this single output state as an input for the signal input.

### FIELD

The present invention relates to an elevator monitoring system and a method for determining elevator status information.

### BACKGROUND

Elevator monitoring systems are well known. For example, WO 2009/150251 A2 discloses a system for monitoring a door of an elevator car and submitting sensor data to a remote monitoring center. Further, from WO 2010/122041 A1 another remote monitoring installation for an elevator system is known. From the prior art it is known to connect multiple sensors to multiple ports of the monitoring controller or the use a communication protocol that allows multiple sensors to communicate with the monitoring controller over a single communication port.

### SUMMARY

An object of the present invention is to provide an elevator monitoring system, which allows to use a technically quite simple sensor for monitoring an elevator installation by a technically simple elevator monitoring solution.

The object of the invention is achieved by the subject-matter of the beneficial embodiments in the descriptions and the drawings.

According to a first aspect, the object is solved by an elevator monitoring system comprising a monitoring controller for communicating with a remote monitoring installation. The monitoring controller comprising a signal input for connecting the monitoring controller to a sensor system of the elevator monitoring system. The sensor system comprises a first sensor module for determining a state of an elevator controller of an elevator system monitored by the elevator monitoring system, and a second sensor module for determining movement information of the monitored elevator system. The sensor system is capable of combining an output state of the first sensor module and an output state of the second sensor module into a single output state by a logical AND operation and provides this single output state as an input for the signal input.

According to a second aspect, the object is solved by a method for determining elevator status information of an elevator system by an elevator monitoring system. The monitoring system comprises a monitoring controller for communicating with a remote monitoring installation. The monitoring controller comprising a signal input, a first sensor module for determining the state of the elevator controller of an elevator system monitored by the elevator monitoring system. Further it comprises a second sensor module for determining movement information of the elevator system. The method comprises:
determining, by the first sensor module, the current state of the elevator controller as a first sensor state,
determining, by the second sensor module, the current movement information as a second sensor state,
combining the first sensor state and the second sensor state by a logical AND operation and
transmitting the result as an input to the monitoring controller of the elevator monitoring system.

In the following, different embodiments of the invention will be discussed.

In a further embodiment, the output state of the first sensor module has during normal operation of the monitored elevator system an opposite value to the output state of the second sensor module during movement of the car of the monitored elevator system.

In a further embodiment, the output state of the first sensor module has during normal operation of the monitored elevator system a value equal to the output state of the second sensor module during the stationary state of the car of the monitored elevator system.

In a further embodiment, the first sensor module is capable of determining the state of the elevator controller by sensing a status indication of the elevator controller.

In a further embodiment, the state of the elevator controller is either “in normal operation” or “out of service”.

In a further embodiment, the second sensor module is capable of determining the movement information by sensing a state of the elevator motor.

In a further embodiment of the method for determining elevator status information, the method comprises:
recording the input to the monitoring controller of the elevator monitoring system over time, and
reconstructing at least two of the following values from the recorded input: operational status of the elevator system, number of trips, total length of travel, and/or relevelling operations.

### DESCRIPTION OF THE DRAWINGS

Exemplifying embodiments of the invention are explained in detail by way of the figures, for which purpose:

FIG. 1 shows an elevator system monitored by an elevator monitoring system.

FIG. 2 shows the elevator monitoring system in more details.

FIG. 3 shows a sensor module of the monitoring system.

FIG. 4 shows a timespan, during which the elevator system is available for accepting calls and the respective output states or signals of a sensor system.

FIG. 5 shows a timespan of the output states or signals of the sensor system during which the elevator system is available for accepting calls at a beginning and changes into a breakdown mode from the time t₁ on.

FIG. 6 shows a timespan of the output states or signals of the sensor system during which the elevator system is available for accepting calls and serving the calls.

FIG. 7 shows a timespan of the output states or signals of the sensor system during which the elevator system is available for accepting calls, serving a call, and doing some releveling maneuver after having served the call.

FIG. 8 shows another embodiment of the elevator monitoring system.

FIG. 9 shows a method for determining elevator status information.

### DETAILED DESCRIPTION

The details of one or more implementations of the subject matter described in this specification are set forth in the accompanying drawings and the description below. Other potential features, aspects, and advantages will become apparent from the description and the drawings.

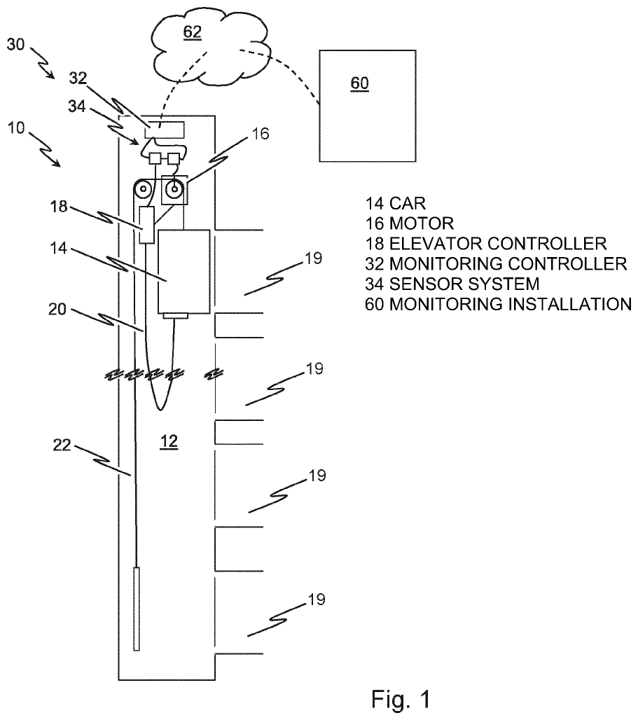

FIG. 1 shows an elevator system 10 installed in an elevator shaft 12 and comprising a car 14 moving within the shaft 12 and driven by a motor 16. A drive of the motor 16 is controlled by an elevator controller 18. The elevator controller 18 is also connected to further parts of the elevator installation such as a car operation panel installed within the car 14 and landing operation panels installed on each floor 19 as well as to further components as required or desired.

For the connection of the different parts of the elevator control wired or wireless communication means can be used. In FIG. 1 a traveling cable 20 is shown for the connection between the elevator controller 18 and the parts of the control being installed on the car 14. Such elevator installations are well known to the person skilled in the art. Also typical variations of elevator installations are well known. FIG. 1 shows an elevator installation making use of a wire rope or a belt 22. Other types of elevator installations like a hydraulic elevator would also be possible.

The elevator system 10 is monitored by an elevator monitoring system 30 comprising a monitoring controller 32 and a sensor system 34. The monitoring controller 32 is capable to communicate with a remote monitoring installation 60 such as a remote monitoring center of an elevator service company or a monitoring application being installed on individual computers of technicians, including mobile devices, or of any another person like a building owner being interested in a current status of an elevator installation.

The connection between the monitoring controller 32 and the remote monitoring installation 60 is typically established by a data connection over the Internet 62. The connection between the monitoring controller 32 and the Internet 62 as well as between the Internet 62 and the remote monitoring installation 60 can be established by a wired or wireless data communication link. Typical examples are Ethernet or other wired data connections. Wired might include electrical wiring as well as connections based on an optical medium. The wireless communication can be established by WiFi, Bluetooth, GMS, LTE, 5G or any other wireless protocol.

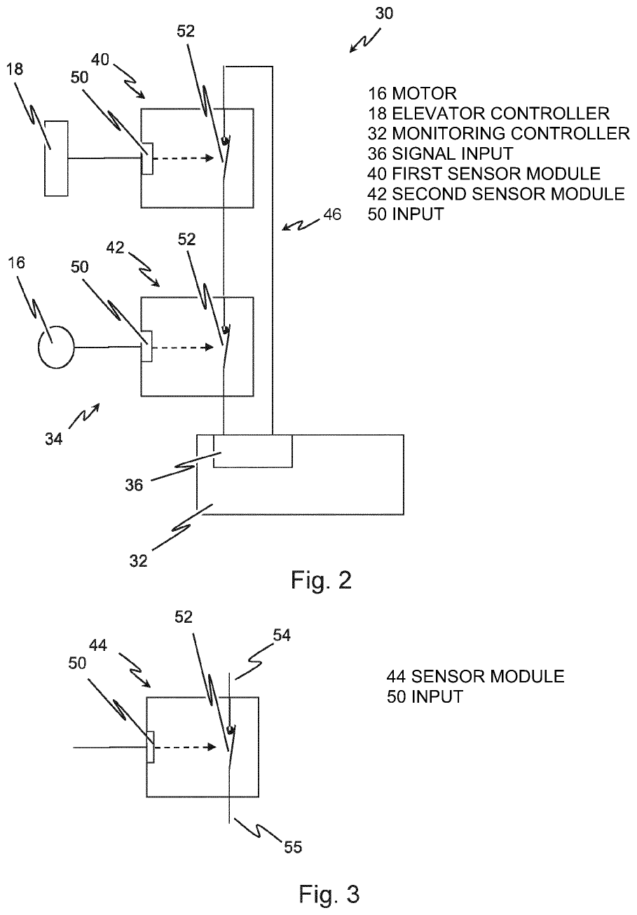

FIG. 2 shows the monitoring system 30 of FIG. 1 in more detail.

The monitoring system 30 comprises a first sensor module 40 and a second sensor module 42, which are serially connected with each other. The sensor system 30, i.e. the first sensor module 40 and the second sensor module 42, is as well connected by a serial connection to a signal input 36 of the monitoring controller 32. In other words, the monitoring controller 32, the first sensor module 40 and the second sensor module 42 are connected in series.

The first sensor module 40 and the second sensor module 42 are essentially of the same type but could also be slightly different. In the following a sensor module 44 will be described, which could be used as the first sensor module 40 as well as for the second sensor module 42.

FIG. 3 shows the sensor module 44. The sensor module 44 has an input 50 for obtaining a measurement signal. This measurement signal can be obtained by various ways. For example, a sensor could be used to sense a voltage, a current or any other observable by a respective sensor. Another possibility is to directly connect a wire to the input 50, which wire is connected at its other end to a specific location within a wiring circuit to be sensed, e.g. into the wiring circuit of the elevator controller 18 as shown for the first sensor module 40 in FIG. 2.

The sensor module 44 has further a switching element 52 which is controlled by the input signal of the sensor module 44. The switching element 52 might be a mechanical switch such as a relay or any electrical switch based on semiconductor technology, like thyristors, IGBT, transistors, etc. An opto-isolator, also known as an optocoupler, could be used for the switching element 52. Further embodiments of a switching element are well known to a person skilled in the art.

The switching element 52 defines the output state of the sensor module 44. The switching element 52 has two states, which states correspond to the information to be determined by the sensor module 44. Examples will be given below for the first sensor module 40 as well as for the second sensor module 42. The switching contacts 54, 55 are electrically connected to each other by the switching element 52 in its closed state. The switching contacts 54, 55 are electrically disconnected from each other by the switching element 52 in its open state.

As shown in FIG. 2, the first sensor module 40 is used to determine if the elevator controller 18 is in a normal operation mode or not. In the normal operation mode, the elevator controller is ready to serve elevator calls. In contrast thereto, the elevator could also be in a breakdown or error mode, in which the elevator controller is not able to serve elevator calls.

There are various possibilities to determine the current mode of the elevator controller 18. For example, many types of available elevator controllers of various manufacturers have status lights, for example an LED, which indicates the current mode of the elevator controller. The light of the LED can be sensed by a light sensor. The output signal of the light sensor can be used as an input for the first sensor module 40.

As already mentioned above, another possibility is to directly attach a wire into the elevator controller 18 and to sense the mode by picking up an electrical signal of the elevator controller and using this signal as the input for the first sensor module 40.

The second sensor module 42 is used to sense a status of the motor 16 or the movement of the car. For this, in the example shown in FIG. 2, a current sensor, such as a hall sensor, can be used to measure a current used to drive the motor 16. As only the information is needed if a rotor of the motor is rotating, but not the actual direction of the rotation or a rotational speed, a quite simple sensor could be used as well. The switching element 52 of the second sensor module 42 is closed in case the motor is in a stationary state. As soon as the motor starts turning the second sensor module 42 is configured to open the switching element 52.

As shown in FIG. 2, the switching element 52 of the first sensor module 40 and the switching element 52 of the second sensor module 42 are serially connected by wires 46 with the signal input 36 of the monitoring controller 32.

In the following, the switching element 52 of the first sensor module 40 and the switching element 52 of the second sensor module 42 will be referred to as the switching elements 52. The first sensor module 40 and the second sensor module 42 will be referred to as the sensor modules 40, 42.

As already described above, the switching elements 52 provides the output states of sensor modules 40, 42. By the serial connection, the output state of the first sensor module 40 and the output state of the second sensor module 42 are combined by a logical AND operation.

This logical AND operation and by the output states of the sensor modules 40, 42 as described above a surprising variety of information can be sensed by a very simple electrical wiring. This will be described with reference to the following figures.

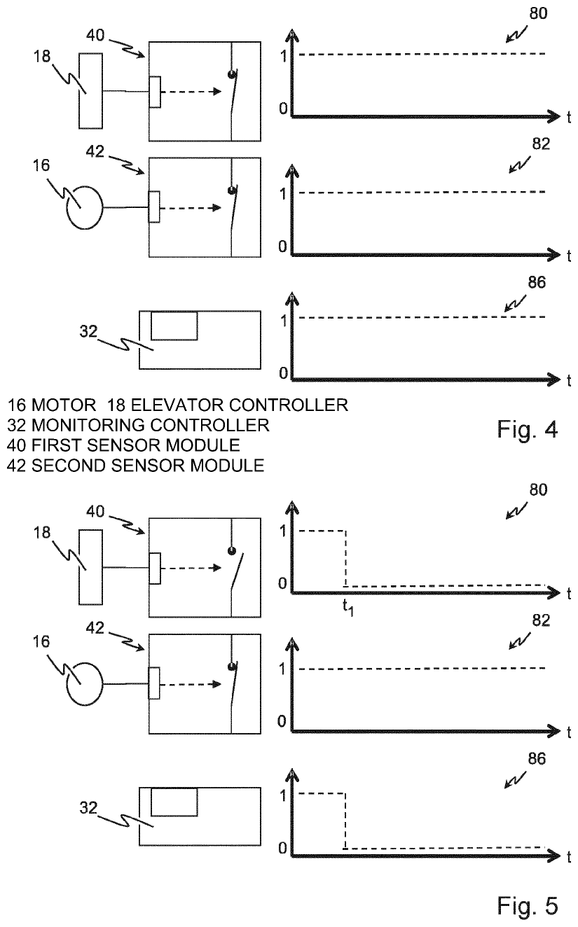

FIG. 4 shows the situation in which the elevator system is available for accepting calls, but is not currently transporting any persons, goods or robots or anything else that might be transported by an elevator. Thus the car is in a stationary state, the motor 16 is not rotating, the brakes are typically closed.

The first sensor module 40 provides an output state that indicates the availability of the elevator system. This state is represented by a logical True, which is equivalent to 1. This status is shown in the graph 80 of the output state of the first sensor module 40 over time.

The second sensor module 42 provides an output state that indicates the stationary state of the elevator car. This state is represented by a logical True, which is equivalent to 1. This status is shown in the graph 82 of the output state of the second sensor module 42 over time.

Also shown in FIG. 4 is the combined output state of the first sensor module 40 and the second sensor module 42, which is shown in the graph 86. The combination is made by a logical AND operation.

FIG. 5 shows the situation in which the elevator system 10 is available for accepting calls until the time t₁. At the time t₁ the elevator controller 18 changes from its available state into a non-available state. The first sensor module 40 provides therefore an output state that indicates the availability of the elevator system until the time t₁ and changes to not-available from time t₁ on. At the time t₁ the output state of the first sensor module 40 changes therefore from True to False, which is equivalent to the change from 1 to 0. In the following True and 1 are used as equivalents. The same applies to False and 0. This is indicated in the graph 80 of the output state of the first sensor module 40. The graph 80 shows again the output state over time.

Over the whole timespan shown in the graphs shown in FIG. 5 the car is in a stationary state, the motor 16 is not rotating and the brakes are typically closed.

The second sensor module 42 provides an output state that indicates the stationary state of the elevator car 14. The state of not moving is represented by a True value. This is indicated in the graph 82 of the output state of the second sensor module 42. The graph 82 shows the output state over time.

Also shown in FIG. 5 is the combined output state of the first sensor module 40 and the second sensor module 42. The combination is made by a logical AND operation.

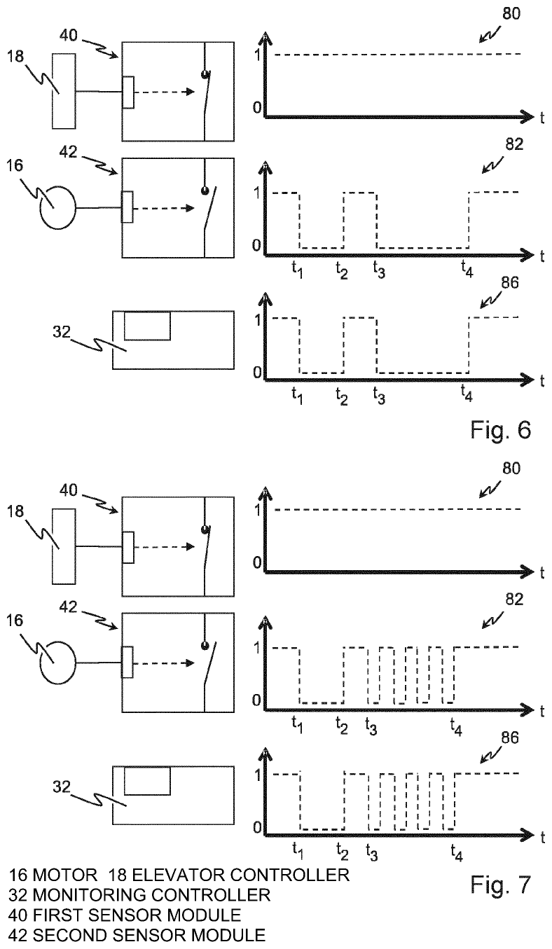

FIG. 6 shows the situation in which the elevator system is available for accepting calls over the whole time shown in the graphs of FIG. 6. The first sensor module 40 provides again an output state that indicates the availability of the elevator system. This is indicated by the True value. In the graph 80 of the output state of the first sensor module 40 this is indicated by a constant True value over time.

Further, the car is not moving until t₁. At t₁ the car starts moving until t₂, which might be due to a travel of the car from one floor to another. A further movement of the car is shown from the time t₃ to t₄.

The second sensor module 42 provides an output state that indicates the stationary state of the elevator car. As the car in this example is travelling from the time t₁ to t₂ and from t₃ to t₄ the graph 86 indicates the stationary state until t₁, from t₂ to t₃ and from t₄ on. The stationary state is indicated in the graph 82 of the output state of the second sensor module 42 as True and as False otherwise. The graph 82 shows the output state over time.

Also shown in FIG. 6 is the combined output state of the first sensor module 40 and the second sensor module 42, which is shown in the graph 86. The combination is made by a logical AND operation.

FIG. 7 shows the situation in which the elevator system is available for accepting calls over the whole time shown in the graphs of FIG. 7. The first sensor module 40 provides again an output state that indicates the availability of the elevator system. This is indicated by the True value. In the graph 80 of the output state of the first sensor module 40 this is indicated by a constant True value over time.

Further, the car is not moving until t₁. At t₁ the car starts moving until t₂, which might be due to a travel of the car from one floor to another. Further movements of the car for only short times are shown from the time t₃ to t₄. Those movements could be caused by releveling actions of the car.

The second sensor module 42 provides again an output state that indicates the stationary state of the elevator car. As the car in this example is travelling from the time t₁ to t₂ and moves from t₃ to t₄ multiple times for only a short period, the graph 82 indicates the stationary state until t₁, from t₂ to t₃ and from t₄ on. The stationary state is indicated in the graph 82 of the output state of the second sensor module 42 as True and as False otherwise. The graph 82 shows again the output state over time. As can be seen from the graph 82, during the time t₃ and t₄ the graph shows multiple short movements.

Also shown in FIG. 7 is the combined output state of the first sensor module 40 and the second sensor module 42, which is shown in the graph 86. The combination is made by the logical AND operation.

From the output state of the above described sensor system 34, which is the combined state of the output states of the first sensor module 40 and the output state of the second sensor module 42 combined by the logical AND operation and provided to the signal input of the monitoring controller 32 the following can be concluded. For the evaluation, the values provided to the signal input 36 are recorded for a period of time, for example the values are kept in a memory of the monitoring controller 32 and/or of a memory of the remote monitoring installation 60. The memory might be any known storage medium which might be a volatile storage medium such as RAM or a non-volatile storage medium such as solid state disc, an EPROM, flash memory, or an electro-mechanical storage medium such as a hard disk drive.

If the signal input 36 is constantly on True or 1, it can be concluded that the elevator system is available. This can be reported by the monitoring controller 32 to a remote monitoring installation 60.

If the signal input 36 is over a longer period of time on False or 0, it can be concluded that the elevator system is not available. This can be reported by the monitoring controller 32 to a remote monitoring installation 60. “A longer period of time” might be a duration longer than one minute, as elevator travels should normally be shorter than 45 seconds.

If the signal input is for a period of time which corresponds to a typical duration of an elevator travel on False or 0, it can be concluded that the elevator is serving a call. A trip counter of the monitoring system can be increased. From the actual duration of the trip and a typical speed of the elevator car 14 also a distance that the car is travelling can be calculated for the trip as well as an accumulated distance. Those values can be reported by the monitoring controller 32 to a remote monitoring installation 60 as well. A “typical duration of an elevator travel” is normally between 6 seconds and 45 seconds.

If the signal input is for a period of time which is shorter than the typical duration of an elevator travel on False or 0 but on True or 1 otherwise, it can be concluded that the elevator car must do some releveling maneuver to bring the elevator car in level with a floor landing. The releveling maneuver can be reported by the monitoring controller 32 as well.

The reported values can be stored on the monitoring system 30 and be reported to the remote monitoring installation 60 upon request. Alternatively or additionally, the monitoring system 30 is reporting the values constantly or the signal input 36 constantly to the remote monitoring installation 60.

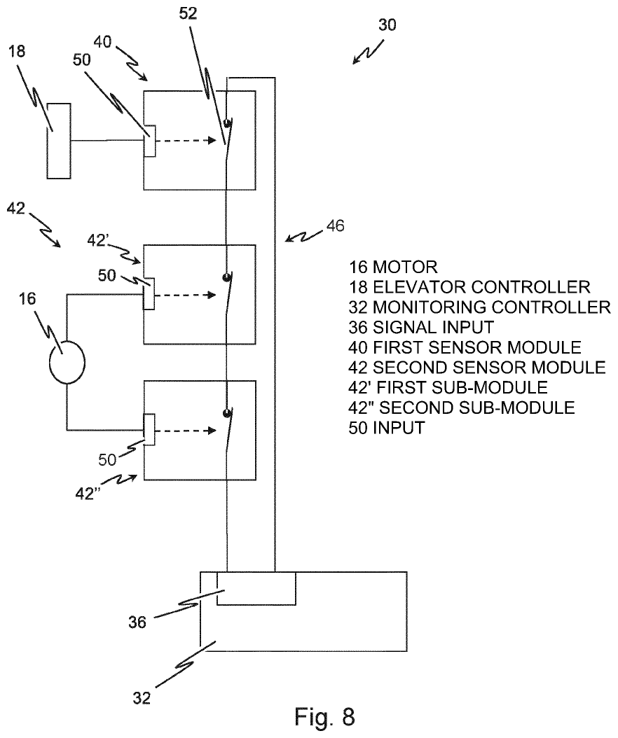

In a further embodiment shown in FIG. 8, the second sensor module 42 comprises a first sub-module 42′ and a second sub-module 42″ which together form the second sensor module 42. For the first sub-module 42′ and the second sub-module 42″ a sensor module 44 as described above with reference to FIG. 3 is used. The output state of the first sub-module 42′ and the output state of the second sub-module 42″ are combined by a logical AND operation. This can be realized again by a serial connection of the first sub-module 42′ and the second sub-module 42″. The first sensor module 40 is again connected in series with the first sub-module 42′ and the second sub-module 42″. This monitoring system 30 can be used, in case the motor 16 or the elevator controller 18 controlling the drive of the motor 16 provides a signal for movements of the motor 16 in one direction and another signal for movements of the motor 16 in the other direction. If the first sub-module 42′ and the second sub-module 42″ report the stationary state, the output state of the second sensor module 42 is True or 1. In case the first sub-module 42′ or the second sub-module 42″ report a movement, the output state of the second sensor module 42 is False or 0.

In a further embodiment, the first sensor module 40 might also be realized by several sub-modules as described for the second sensor module 42 with respect to FIG. 8. It should also be noted that the sub-modules for the first sensor module as well for the second sensor module could be arranged in parallel so that the output states of the sub-modules would be combined by a logical OR operation.

In a further embodiment, the first sensor module might detect the non-availability of the elevator system to be monitored. In such a case, the sensor module has an additional operation to invert the output state. This could be realized by an inverter for controlling the switching element or by choosing a switching element with inverted control.

In a further embodiment, the first sensor module and the second sensor module provide a single logical output state or an output signal. The output signals might be combined by a logic unit implementing a logical AND in an integrated circuit. The output of the logical AND could be provided as the output of the sensor unit and used as the input for the signal input of the monitoring controller.

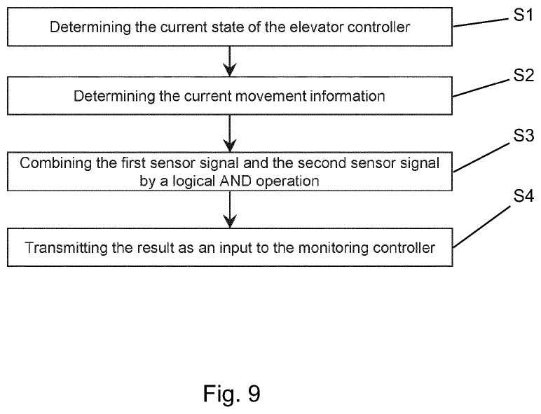

The method for determining elevator status information, according to the invention, is shown in FIG. 9. The method comprises the steps of:
S1 determining, by the first sensor module, the current state of the elevator controller as a first sensor state;
S2 determining, by the second sensor module, the current movement information as a second sensor state;
S3 combining the first sensor state and the second sensor state by a logical AND operation; and
S4 transmitting the result as an input to the monitoring controller of the elevator monitoring system.

In accordance with the provisions of the patent statutes, the present invention has been described in what is considered to represent its preferred embodiment. However, it should be noted that the invention can be practiced otherwise than as specifically illustrated and described without departing from its spirit or scope.

1-8. (canceled)

9. An elevator monitoring system comprising:
a monitoring controller communicating with a remote monitoring installation, the monitoring controller including a signal input;
a sensor system connected to the signal input;
wherein the sensor system includes a first sensor module determining a state of an elevator controller of an elevator system monitored by the elevator monitoring system and includes a second sensor module determining movement information of the monitored elevator system; and
wherein the sensor system combines an output state of the first sensor module with an output state of the second sensor module into a single output state by a logical AND operation and provides the single output state as an input to the signal input.

10. The elevator monitoring system according to claim 9 wherein the output state of the first sensor module has during a normal operation of the monitored elevator system an opposite value to a value of the output state of the second sensor module during movement of a car of the monitored elevator system.

11. The elevator monitoring system according to claim 9 wherein the output state of the first sensor module has during a normal operation of the monitored elevator system a value equal to a value of the output state of the second sensor module during a stationary state of a car of the monitored elevator system.

12. The elevator monitoring system according to claim 9 wherein the first sensor module determines the state of the elevator controller by sensing a status indication of the elevator controller.

13. The elevator monitoring system according to claim 12 wherein the state of the elevator controller is either “in normal operation” or “out of service”.

14. The elevator monitoring system according to claim 9 wherein the second sensor module determines the movement information by sensing a state of an elevator motor of the monitored elevator system.

15. A method for determining elevator status information of an elevator system using an elevator monitoring system, the monitoring system including a monitoring controller communicating with a remote monitoring installation, the monitoring controller having a signal input, a first sensor module determining a state of an elevator controller of the elevator system and a second sensor module determining movement information of the elevator system, the method comprising the steps of:
determining by the first sensor module a current state of the elevator controller as a first sensor state;
determining by the second sensor module a current movement information as a second sensor state;
combining the first sensor state and the second sensor state by a logical AND operation; and
transmitting a result of the combining as an input to the monitoring controller of the elevator monitoring system.

16. The method for determining elevator status information according to claim 15 further comprising:
recording the input to the monitoring controller of the elevator monitoring system over a timespan; and
reconstructing, from the recorded input, values of at least two of operational status of the elevator system, number of trips, total length of travel, and relevelling operations.
